(19) United States
(12) Patent Application Publication
(10) Pub. No.: US 2016/0080555 A1
(43) Pub. Date: Mar. 17, 2016

(54) SPACE MANAGEMENT SYSTEM FOR MICROPOSITIONING MOBILE DEVICE AND MANAGEMENT METHOD THEREOF

(71) Applicant: iSecurity Incorporation, Taipei City (TW)

(72) Inventors: Ti SU, Taipei City (TW); Ren-Tsai CHEN, Taipei City (TW)

(21) Appl. No.: 14/841,183

(22) Filed: Aug. 31, 2015

(30) Foreign Application Priority Data
Sep. 12, 2014 (TW) 103131594

(51) Int. Cl. H04M 1/725; H04W 4/00

(52) U.S. Cl. CPC H04M 1/72577; H04W 4/008

(57) ABSTRACT

A space management system for micropositioning mobile device and a management method thereof is disclosed. At least one low-power bluetooth device is distributed in an environment and at least one mobile device comprises a bluetooth transmission module and a management control module. Each low-power bluetooth device continuously emits a control signal. The bluetooth transmission module receives the control signal emitted by at least one low-power bluetooth device to drive the management control module, and then the management control module closes or locks at least one function of the mobile device according to at least one limitation condition preset by the management control module.

This application claims priority for Taiwan patent application no. 103131594 filed on Sep. 12, 2014, the content of which is incorporated by reference in its entirely.

### BACKGROUND OF THE INVENTION

1. Field of the Invention

The present invention relates to a technology for managing a mobile device, particularly to a space management system for micropositioning a mobile device and a management method thereof.

2. Description of the Related Art

The functions of mobile devices are gradually improved, such as cameras with more pixels and microphones with better reception and sound quality. In addition, the abilities of programs are also enhanced. For example, instant messaging software not only transmits words but also transmits files with other formats. Instant messaging software can transmit them to a cloud database immediately. A receiver can log in the instant messaging software from a host at any time to download the files. A transmitter can directly transmit the files without waiting for the receiver to press down “OK” button. The technology is quite convenient.

The improved functions of the mobile devices caused some problems. For example, since some factories and companies fear that products are photographed before marketing or that business secrets are revealed, workers or visitors are asked to hand in the mobile devices. This makes it hard to communicate with a person concerned for urgent business. Besides, although photographing behaviors does not occur during a meeting, the mobile devices are used to record in private or the mobile devices ring to interrupt the meeting. As a result, how to manage the mobile devices of users in different situations without seizing the mobile devices is a problem.

To overcome the abovementioned problems, the present invention provides a space management system for micropositioning mobile device and a management method thereof, so as to solve the afore-mentioned problems of the prior art.

### SUMMARY OF THE INVENTION

A primary objective of the present invention is to provide a space management system for micropositioning mobile device and a management method thereof, which installs at least one low-power bluetooth device in an environment to establish a signal range and manages mobile devices in the signal range, whereby a part of preset functions of the mobile devices in the signal range is closed or locked to maintain privacy of an internal space.

Another objective of the present invention is to provide a space management system for micropositioning mobile device and a management method thereof, which

A further objective of the present invention is to provide a space management system for micropositioning mobile device and a management method thereof. When the system comprises only one low-power bluetooth device, the low-power bluetooth device is installed at an entrance of a space to manage the mobile devices that will enter the space.

A further objective of the present invention is to provide a space management system for micropositioning mobile device and a management method thereof. When the system comprises at least three low-power bluetooth devices, the low-power bluetooth devices are distributed around an environment. The signal range of the low-power bluetooth devices can define a control space in the environment, whereby the function of the mobile device entering the space is locked.

A further objective of the present invention is to provide a space management system for micropositioning mobile device and a management method thereof, which uses a management host at a far end to synchronize with a management control module of a mobile device, so as to change the limitation condition preset by the mobile device at all times.

To achieve the abovementioned objectives, the present invention provides a space management system for micropositioning mobile device, which comprises at least one low-power bluetooth device distributed in an environment and at least one mobile device comprising a bluetooth transmission module and a management control module. Each low-power bluetooth device continuously emits a control signal. The bluetooth transmission module receives the control signal emitted by at least one low-power bluetooth device to drive the management control module, and then the management control module closes or locks at least one function of the mobile device according to at least one limitation condition preset by the management control module.

The present invention also provides a management method of space management system for micropositioning mobile device comprising steps of: installing a management control module in a mobile device; at least one low-power bluetooth device distributed in an environment, and each low-power bluetooth device continuously emits a control signal; and when a bluetooth transmission module of the mobile device receiving said control signal emitted by at least one low-power bluetooth device, the bluetooth transmission module drives the management control module, and then the management control module closes or locks at least one function of the mobile device according to at least one limitation condition preset by the management control module.

Below, the embodiments are described in detail in cooperation with the drawings to make easily understood the technical contents, characteristics and accomplishments of the present invention.

### BRIEF DESCRIPTION OF THE DRAWINGS

FIG. 1 is a block diagram showing a space management system for micropositioning mobile device according to an embodiment of the present invention;

FIG. 2A is a diagram schematically showing a space management system for micropositioning mobile device according to an embodiment of the present invention;

FIG. 2B is a diagram showing a flowchart of a management method of the space management system in FIG. 2A of the present invention;

FIG. 3A is a diagram schematically showing a space management system for micropositioning mobile device according to another embodiment of the present invention; and

FIG. 3B is a diagram showing a flowchart of a management method of the space management system in FIG. 3A of the present invention.

### DETAILED DESCRIPTION OF THE INVENTION

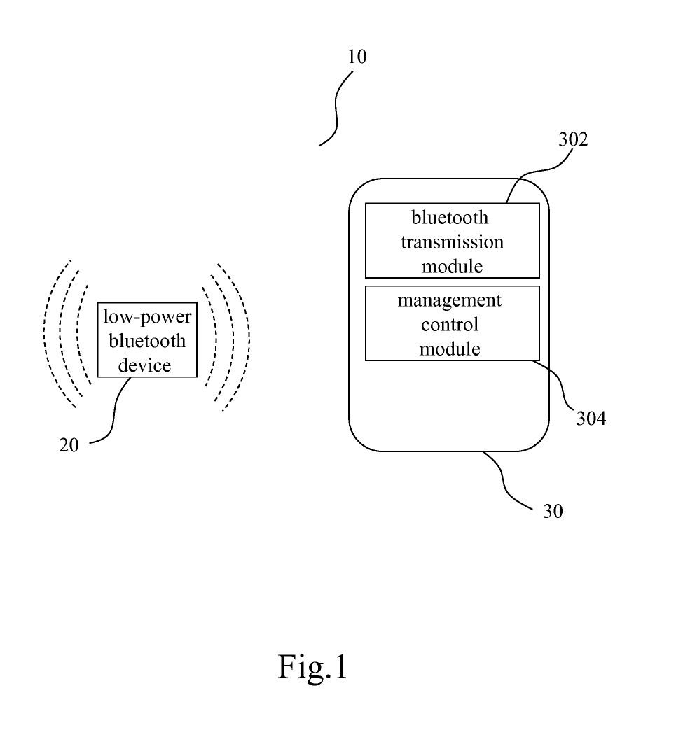

The present invention provides a space management system for micropositioning mobile device and a management method thereof. Refer to FIG. 1, which is a block diagram showing a space management system for micropositioning mobile device according to an embodiment of the present invention. The management system comprises at least one low-power bluetooth device 20 such as an iBeacon and at least one mobile device 30. The low-power bluetooth device 20 is distributed in an environment 10. Low-power bluetooth communication software is built in each low-power bluetooth device 20. The low-power bluetooth communication software is indoor position software. Each low-power bluetooth device 20 uses the low-power bluetooth communication software to continuously emit a control signal to microposition the mobile device 30. The control signals with different strengths have different sensing ranges. Since the low-power bluetooth communication software is a short-distance positioning technology, it has signal range of within 3-5 meters. The mobile device 30 comprises a bluetooth transmission module 302 and a management control module 304. The bluetooth transmission module 302 receives the control signal emitted by at least one low-power bluetooth device 20 to automatically drive the management control module 304, and then the management control module 304 closes or locks at least one function of the mobile device 30 according to at least one limitation condition preset by the management control module 304, wherein the limitation condition corresponds to the function.

The limitation condition defines to close or lock a function of camera, microphone, network or communication.

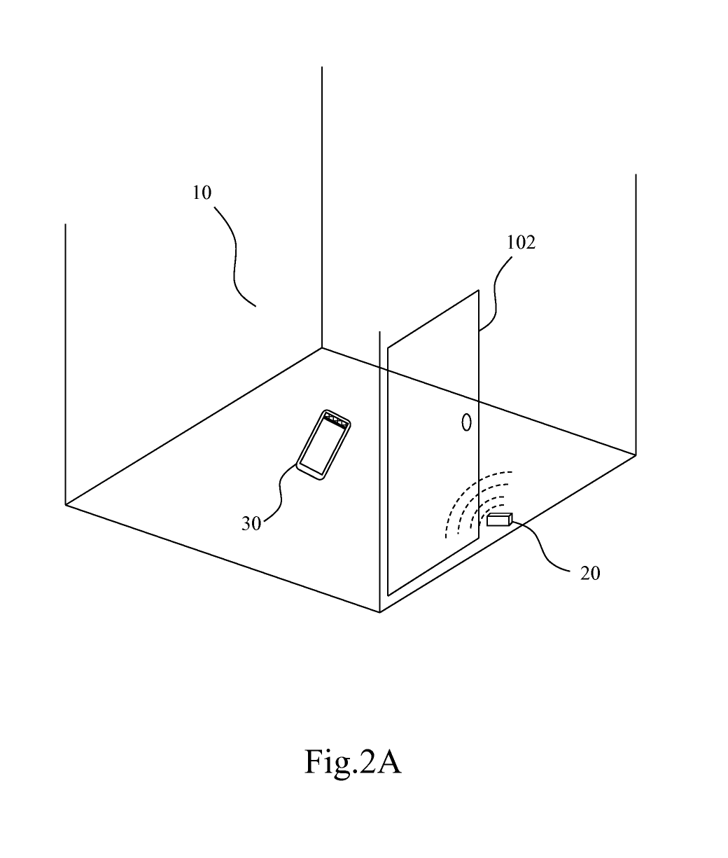

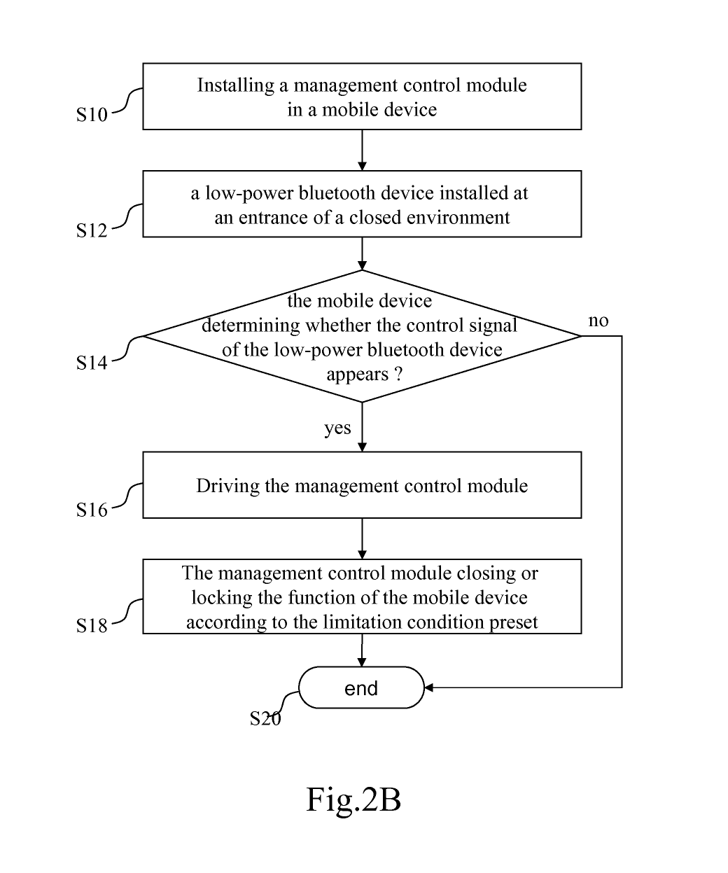

FIG. 2A is a diagram schematically showing a space management system for micropositioning mobile device according to an embodiment of the present invention. Refer to FIG. 2A and FIG. 2B. Firstly, in Step S10, a management control module is installed in a mobile device 30. The management control module is an application program installed in the mobile device 30 to control the functional elements of the mobile device 30. Then, in Step S12, a low-power bluetooth device 20 is installed in an environment 10, such a conference room as a closed environment of FIG. 2A. The low-power bluetooth device 20 is installed at an entrance 102 and continuously emits a control signal. In Step S14, the bluetooth transmission module of the mobile device 30 continuously determines whether the control signal of the low-power bluetooth device 20 appears around the bluetooth transmission module. If the bluetooth transmission module detects the control signal, Step 16 is executed. If the bluetooth transmission module does not detect the control signal, the mobile device 30 maintains its normal mode. In Step S16, the management control module is driven. Then, in Step S18, the management control module closes or locks at least one function of the mobile device 30 according to at least one limitation condition preset by the management control module. For example, when a user enters the conference room, the mobile device 30 of the user detects the control signal of the low-power bluetooth device 20 at the entrance of the conference room. After the mobile device 30 drives the management control module, the function of photographing and recording of the mobile device 30 is closed or locked. Thus, the mobile device 30 cannot photograph and record to avoid revealing meeting content.

The activity that the mobile device 30 is driven to close or lock the limitation condition is set by a management host (not shown) at a far end. The management control module of each mobile device 30 synchronizes with the management host. As a result, when the management host changes the limitation condition, the mobile device 30 synchronously updates the limitation condition. For example, only the function of photographing and recording of the mobile device 30 is initially locked. After the management host adds one limitation condition related to network transmission, the management control module of the mobile device 30 synchronously closes the function of network transmission of the mobile device 30 capable of initially accessing the Internet in the conference room. In other words, the mobile device 30 no longer has the ability of network transmission.

The low-power bluetooth device 20 also synchronizes with the management host. The control signal of the low-power bluetooth device 20 is used to drive the management control module to lock or close the functional element. Besides, the low-power bluetooth device 20 also emits the control signal related to “unlock”. The low-power bluetooth device 20 emits the control signal related to “lock” or “unlock”, which is determined by the management host. Take the abovementioned embodiment for example. At the end of the meeting, the management host changes the operation mode of the low-power bluetooth device 20. Instead of emitting the control signal related to “lock”, the low-power bluetooth device 20 emits the control signal related to “unlock”. When the user leaves the meeting room through the entrance, the mobile device 30 detects the control signal emitted by the low-power bluetooth device 20, and then the management control module uses the control signal related to “unlock” to recover the function closed or locked.

The management host stores media access control number (MAC number), universally unique identifier (UUID), major number and minor number of each low-power bluetooth device 20. The management host stores at least one device-identifying data provided by each mobile device 30, such as an international mobile equipment identity number (IMEI) or a machine serial number.

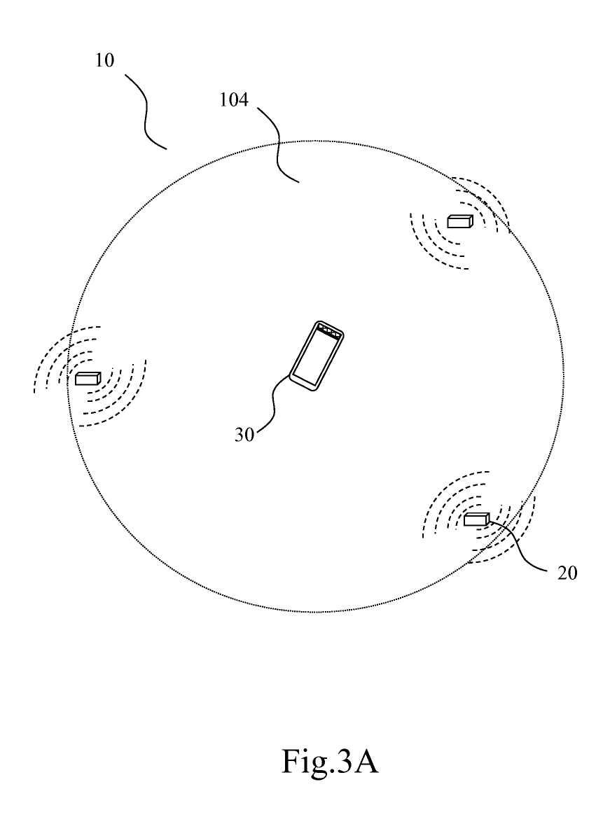

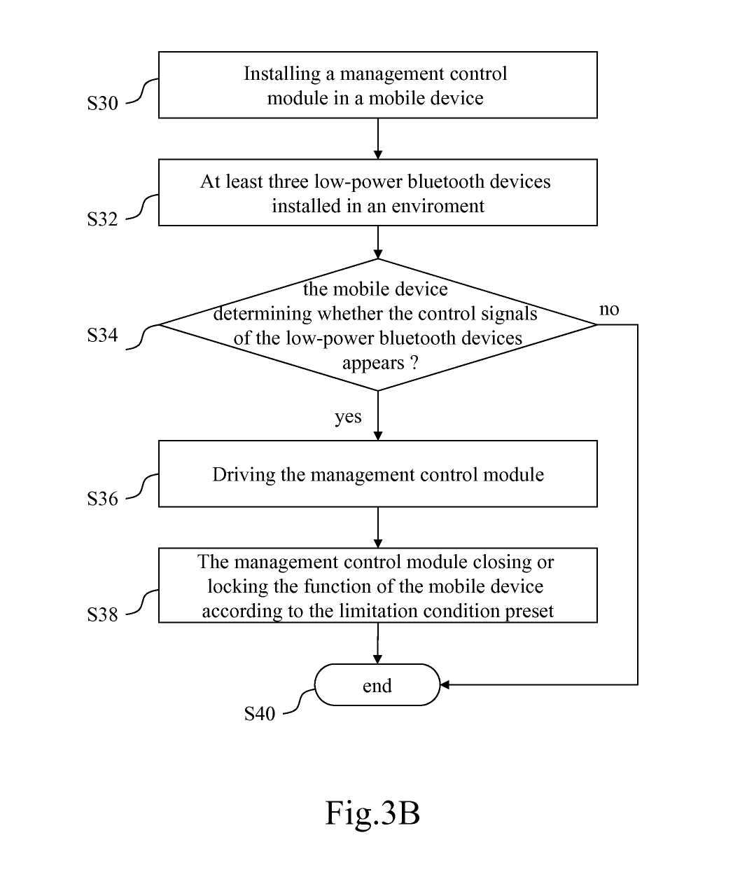

FIG. 3A is a diagram schematically showing a space management system for micropositioning mobile device according to another embodiment of the present invention. Refer to FIG. 3A and FIG. 3B. Step S30 is the same to Step S10. In Step S30, a management control module is installed in a mobile device 30 to control the functional elements of the mobile device 30. Then, in Step S32, at least three low-power bluetooth devices 20 are installed in an environment 10, such as an exhibition hall as an open environment of FIG. 3A or a space with a diameter larger than 5 meters. The low-power bluetooth devices 20 are distributed in the environment 10. The low-power bluetooth device 20 continuously emits a control signal. In Step S34, the bluetooth transmission module of the mobile device 30 continuously determines whether the control signal of the low-power bluetooth device 20 appears around the bluetooth transmission module. If the bluetooth transmission module detects the control signal, Step 36 is executed. If the bluetooth transmission module does not detect the control signal, the mobile device 30 maintains its normal mode. In Step S36, the management control module is driven. Then, in Step S38, the management control module closes or locks at least one function of the mobile device 30 according to at least one limitation condition preset by the management control module. FIG. 2A is different from FIG. 3A in that the three low-power bluetooth devices 20 form a control space 104 in the environment 10. In addition to limiting the function of the mobile device 30 entering the control space 104, the low-power bluetooth devices 20 can position the mobile device 30 by triangulation to precisely find the location of the mobile device 30 lest the mobile device 30 outside the control space 104 be misjudged.

For example, the environment is a factory divided into many laboratories. At least three low-power bluetooth devices are installed in each laboratory, as shown in FIG. 3A. The different control spaces are respectively formed in different laboratories. The different control spaces respectively have different limitation conditions, such as forbidding photographing and recording in laboratory A or forbidding photographing, recording and communicating in laboratory B. These limitation conditions corresponding to the mobile devices respectively entering different laboratories are managed by the management host. For instance, after the mobile device enters the control space formed by the low-power bluetooth devices NO. 001˜003, the mobile device receives the control signals emitted by the low-power bluetooth devices to drive the management control module. Then, the mobile device knows the function limited or locked by the control space formed by the low-power bluetooth devices NO. 001˜003 from the management host, and closes or locks the function.

Even the user closes the network connection of the mobile device (for example, the bluetooth transmission module is turned off), the management control module itself still turns on the bluetooth transmission module of the mobile device to receive the control signal emitted by the low-power bluetooth device, thereby opening the network connection, and either closing or locking the function preset.

In conclusion, the space management system for micropositioning mobile device and the management method thereof of the present invention combines the low-power bluetooth device with the management control module of the mobile device, uses the low-power bluetooth device to microposition the mobile device, and uses the control signal emitted by the low-power bluetooth device to drive the management control module of the mobile device to close or lock a part of functions of the mobile device. As a result, the information or secrets within the control space are not revealed. In addition, the management host at the far end controls the limitation condition, changes it at all times, and transfers “lock state” into “unlock state”. The present invention is more suitable for management in a company. When users enter the company, their mobile devices no longer are seized. In the company, the present invention can limit and manage the function of the mobile device according to areas with different degrees of secrecy.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A space management system for micropositioning mobile device comprising:
at least one low-power bluetooth device distributed in an environment, and each said low-power bluetooth device continuously emits a control signal; and
at least one mobile device comprising a bluetooth transmission module and a management control module, and said bluetooth transmission module receives said control signal emitted by at least one said low-power bluetooth device to drive said management control module, and then said management control module closes or locks at least one function of said mobile device according to at least one limitation condition preset by said management control module.

2. The space management system for micropositioning mobile device according to claim 1, further comprising a management host, which synchronizes with said management control module, and said management host controls said management control module of each said mobile device from a far end, and sets activity that said management control module is driven to close or lock said function.

3. The space management system for micropositioning mobile device according to claim 1, wherein said limitation condition defines to close or lock a function of camera, microphone, network or communication.

4. The space management system for micropositioning mobile device according to claim 1, wherein when an amount of said low-power bluetooth device is equal to or larger than three, said low-power bluetooth devices microposition said mobile device.

5. The space management system for micropositioning mobile device according to claim 2, wherein management data corresponding to said function of said mobile device locked by said management host is stored in said mobile device.

6. The space management system for micropositioning mobile device according to claim 2, wherein said management host stores media access control number (MAC number), universally unique identifier (UUID), major number and minor number of each said low-power bluetooth device.

7. The space management system for micropositioning mobile device according to claim 2, wherein said management host stores at least one device-identifying data comprising an international mobile equipment identity number (IMEI) or a machine serial number.

8. A management method of space management system for micropositioning mobile device comprising steps of:
installing a management control module in a mobile device;
at least one low-power bluetooth device distributed in an environment, and each said low-power bluetooth device continuously emits a control signal; and
when a bluetooth transmission module of said mobile device receiving said control signal emitted by at least one said low-power bluetooth device, said bluetooth transmission module drives said management control module, and then said management control module closes or locks at least one function of said mobile device according to at least one limitation condition preset by said management control module.

9. The management method of space management system for micropositioning mobile device according to claim 8, wherein said management control module synchronizes with a management host at a far end.

10. The management method of space management system for micropositioning mobile device according to claim 9, wherein said management host controls said management control module of each said mobile device from a far end, and sets activity that said management control module is driven to close or lock said function.

11. The management method of space management system for micropositioning mobile device according to claim 8, wherein said function is related to camera, microphone, network or communication.

12. The management method of space management system for micropositioning mobile device according to claim 8, wherein when an amount of said low-power bluetooth device is equal to or larger than three, said low-power bluetooth devices microposition said mobile device.

13. The management method of space management system for micropositioning mobile device according to claim 9, wherein management data corresponding to said function of said mobile device locked by said management host is stored in said mobile device.

14. The management method of space management system for micropositioning mobile device according to claim 9, wherein after said management control module is installed in said mobile device, said mobile device transmits at least one device-identifying data to said management host and stores said device-identifying data in said management host, said device-identifying data comprises an international mobile equipment identity number (IMEI) or a machine serial number.
